(19) United States
(12) Patent Application Publication
(10) Pub. No.: US 2011/0248525 A1
(43) Pub. Date: Oct. 13, 2011

(54) PARTIALLY TRANSPARENT VEHICLE BODY COMPONENT

(75) Inventor: Jesper LUNDSTROEM, Vaenersborg (SE)

(73) Assignee: GM GLOBAL TECHNOLOGY OPERATIONS LLC, Detroit, MI (US)

(21) Appl. No.: 13/081,240

(22) Filed: Apr. 6, 2011

(30) Foreign Application Priority Data
Apr. 7, 2010 (GB) 1005737.0

(51) Int. Cl. B62D 25/02; B62D 25/04

(52) U.S. Cl. 296/191; 296/193.06

(57) ABSTRACT

A vehicle body component is provided that includes, but is not limited to a first and a second structural member that are interconnected by a panel member that is at least partially transparent.

### CROSS-REFERENCE TO RELATED APPLICATION

This application claims priority to British Patent Application No. 1005737.0, filed Apr. 7, 2010, which is incorporated herein by reference in its entirety.

### TECHNICAL FIELD

The technical field generally relates to a vehicle body component being at least partially transparent for electromagnetic radiation in the visible spectral range.

### BACKGROUND

Due to permanently increasing demands with respect to passenger safety, body components of automotive vehicles have to provide improved mechanical stability and rigidity, preferably without substantially increasing the overall weight of the vehicle. Depending on such mechanical demands and prerequisites, certain vehicle body components constantly grow in size and diameter. In particular for such body components being arranged and located in the field of view of a driver or other passengers of a respective vehicle their size indeed matters.

In particular A- and B-pillars of a vehicle body at least partial obstruct the field of view of the driver of the vehicle. In such cases, where the A- and/or B-pillar sections feature a comparatively large diameter, from a driver's point of view, other road users, in particular pedestrians, might be concealed by such pillar structures. Such an obstruction might become perilous and is considered as being disadvantageous in view of pedestrian and general road safety.

In document DE 10 2007 060 870 A1 a structural component of a vehicle body is disclosed comprising a so-called meta material. The meta material comprises a thin film structure having microscopic metal wirings forming an electromagnet. By way of the electromagnetic properties of the meta material, magnetic properties of visible light become manipulable. Hence, visible light can be bended around a pillar structure. In this way it is possible, that surroundings lying behind a vehicle component in view of the vehicle driver become visible for the driver of the vehicle.

Development of such meta materials is still in an experimental stage. Additionally, these materials are rather sensitive and expensive. It is therefore at least one object to provide a vehicle body providing beneficial properties with respect to the field of view of the vehicle driver and which enables to provide new and improved concepts for passenger and road safety. In addition, other objects, desirable features and characteristics will become apparent from the subsequent summary and detailed description, and the appended claims, taken in conjunction with the accompanying drawings and this background.

### SUMMARY

A first embodiment refers to a vehicle body component comprising at least a first and a second structural member that are interconnected by a panel member. First and second structural members are arranged in a pre-defined distance from each other, and the panel member, typically comprising a planar shape extends there between. The panel member is at least partially transparent for visible light and therefore reduces the degree of obstruction of a vehicle driver's field of view.

Preferably, the entire panel member is transparent or at least partially transparent. Alternatively, the panel member only comprises particular sections being at least partially transparent to visible light. Instead of a bulky and rather spacious structural member, the invention suggests to make use of at least two structural members that are preferably aligned and oriented substantially parallel to each other.

The first and second structural members may therefore comprise smaller dimensions in the field of view of the driver compared to a conventional one-piece body component. By interconnecting first and second structural members by means of an at least partially transparent panel member, overall stiffness and rigidity of the vehicle body component can be maintained or even enhanced compared to a conventional one-piece vehicle body component. Additionally, the transparency of the panel member allows to visually detect objects and in particular persons located behind the vehicle body component from a driver's point of view.

In an embodiment, the panel member comprises a perforated structure. Hence, the panel member of substantially plane shape comprises regularly or irregularly arranged through openings of identical or variable size. In a further embodiment, the panel member comprises sheet metal, in particular sheet steel. Depending on mechanical and rigidity prerequisites, the panel member may even comprise lightweight sheet metal, in particular aluminum. The size and the spatial distribution of the perforations in the sheet metal structure may vary along the panel's extension and may depend on mechanical load demands.

In an embodiment, the vehicle body component is designed as an A-, B-, and/or C-pillar of the vehicle body. The A-pillar is for instance divided into two parallel oriented structural members encompassing the at least partially transparent panel member. In this way, the A-pillar becomes at least partially transparent such that objects or persons located behind the respective pillar, which would otherwise be obstructed by a conventional pillar, become visually detectable for the drive of the vehicle.

In a further embodiment, the first and the second structural member form a closed frame member, wherein an inner section of said frame member is traversed by the at least partial transparent panel member. By having a closed frame structure, mechanical stiffness and rigidity of first and second structural members can be enhanced.

In another embodiment, the panel member is integrally formed with at least one of the first and/or second structural members. In this way, the panel member does not have to be separately interconnected with respective first and/or second structural members. In particular, the integrated unit of structural member and panel member can be manufactured by way of a roll forming procedure, which is particularly beneficial in terms of production costs and expenditure.

Furthermore, and according to another embodiment, the first and the second structural members mutually merge. For instance, when designed as an A-pillar, the vehicle component may be interconnected to a belt line structure of the vehicle body. Then, first and second structural members extend in the form of a Y-branch only in the field of view and along a window aperture of the vehicle body. In an upper section, first and second structural members may re-merge or may be separately connected with a roof top structure of the vehicle body.

In a further embodiment, the panel member comprises a plane or bended shape. For instance, first and second structural members of an A-pillar may be arranged in an arch-like way. The interconnecting panel member is at least slightly bended along its short axis.

In another embodiment, the panel member and at least one of first and/or second structural members form an assembly unit, which is adapted to be assembled to the vehicle's body as a whole. By way of arranging first and second structural members and the panel member in a pre-configurable assembly unit, a respective pillar-module can be manufactured independently from the residual vehicle body. Manufacture and supply of such an assembly unit can then for instance be provided by external automotive suppliers. The OEM manufacturer then only has to assemble the pre-configured assembly unit with the vehicle body.

In a further embodiment, at least one of the structural members comprises a closed profile, by way of which an enhanced mechanical stability and mechanical rigidity can be provided. Also here, the closed profile, eventually integrally formed with the panel member, can be manufactured by way of a roll forming procedure.

In another embodiment, at least one of the structural members comprises an open profile. Such profiles may be of u- or v-shaped structure. In particular, having both structural members at least partially shaped as a u-profile, the panel member can be connected with a side shank portion of first and second structural members, respectively. In this way, first and second structural members and the interconnecting panel member comprise a c-shaped cross-sectional profile.

In another embodiment, an A-, B- and/or C-pillar of a body of a vehicle, comprising a vehicle body component as described above. Moreover, an automotive vehicle is provided comprising the above-described vehicle body component and/or a respective A-, B- or C-pillar.

### BRIEF DESCRIPTION OF THE DRAWINGS

The present invention will hereinafter be described in conjunction with the following drawing figures, wherein like numerals denote like elements, and:

FIG. 1 shows a partially transparent perspective view of a vehicle body;

FIG. 2 shows a cross section of an A-pillar according to a first embodiment;

FIG. 3 shows a cross-sectional illustration of an A-pillar according to a second embodiment; and

FIG. 4 shows an A-pillar as seen from outside the vehicle.

### DETAILED DESCRIPTION

The following detailed description is merely exemplary in nature and is not intended to limit application and uses. Furthermore, there is no intention to be bound by any theory presented in the preceding background or summary or the following detailed description.

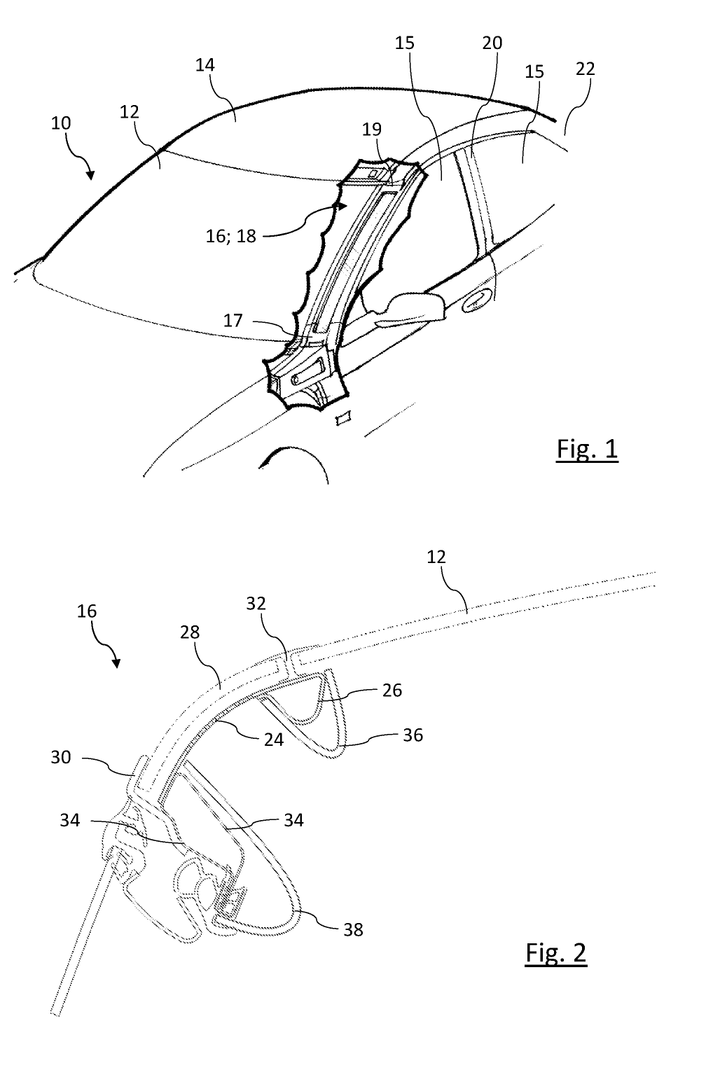

FIG. 1, in a perspective illustration shows an automotive vehicle 10 comprising a windscreen 12, an A-pillar 16, 18, a B-pillar 20, a C-pillar 22 as well as a roof top 14. Additionally, a window aperture 15 is illustrated.

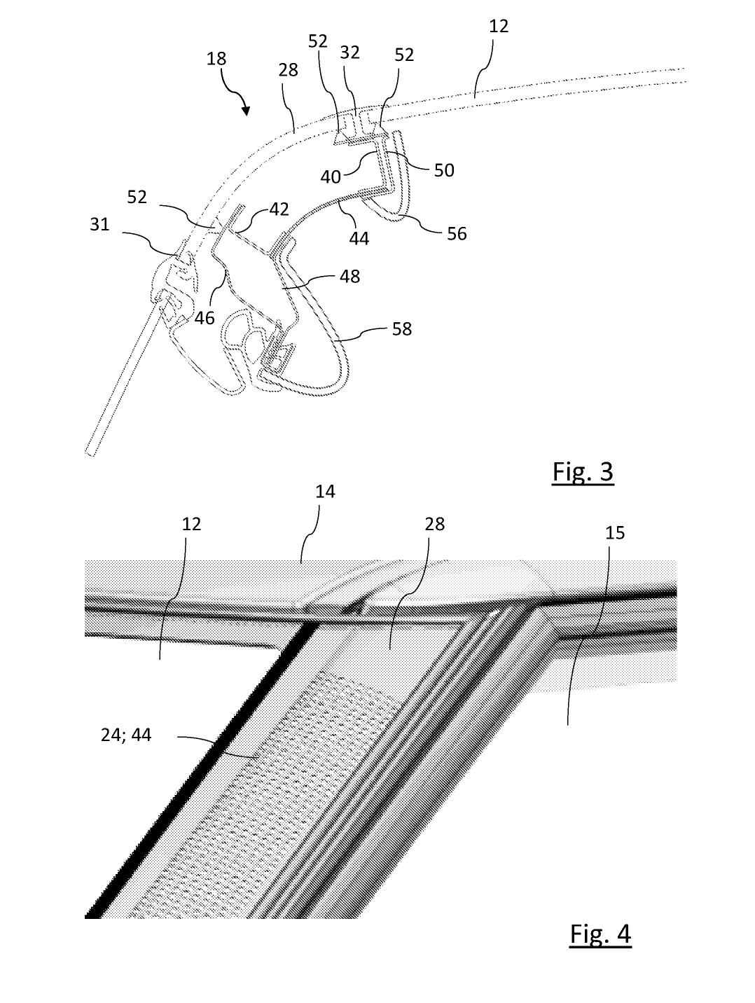

The A-pillar 16, 18 comprises two longitudinal bars or respective first and second structural members extending from the body's belt line towards the roof top structure 14 of the vehicle. In FIG. 2 and FIG. 3, two alternative embodiments of an internal structure of an A-pillar 16, 18 are illustrated, respectively.

The A-pillar 16 according to FIG. 2 comprises two structural members 26, 34, which substantially extend along the generic elongation of the A-pillar 16. Here, the structural member 26 is designed as a closed somewhat triangular-shaped longitudinal profile, which is integrally formed with an elongated panel member 24 extending towards the second structural member 34 that forms a part of an outer body-in-white-structure of the vehicle body. The panel member 24 is perforated, as for instance disclosed in FIG. 4. The panel member 24 is therefore at least partially transparent for electromagnetic radiation in the visible spectral range. The structural member 34 is also designed as a closed longitudinal profile. Both structural members 26, 34 are covered towards the inside of a passenger compartment by means of interior linings 36, 38.

The perforated panel member 24 is rigidly and unreleasably connected with an outer portion of the structural member 34, e.g. by welding, bonding or similar fastening means. The structural member 34 also serves as a support for a mount 30 and the other structural member 26 provides a support for another T-shaped mount 32. The two mounts 30, 32 serve to provide a fixing means for a windscreen 12 and/or for an at least partially transparent cover 28 to be arranged between the first and second structural members 26, 34.

In the embodiment according to FIG. 2, the perforated panel member 24 is arranged and positioned at an outward facing section of first and second structural members 26, 34.

In the embodiment according to FIG. 3, a respective partially transparent panel member 44 is arranged at an inward facing section of respective first and second structural members 40, 42. Here, and in contrast to the configuration of FIG. 2, first and second structural members 40, 42 comprise a u-shaped cross section, wherein the interconnecting panel member 44 is connected to respective side shank portions of the u-profiled structural members 40, 42. This way, structural members 40, 42 and the interconnecting panel member 44 form a convex shaped C-profile structure.

Additionally, first and second structural members 40, 42 are connected to further structural members 46, 48, 50, wherein mutual interconnection of structural members 42, 46, 48 forms a closed profile and wherein mutual interconnection of structural members 40, 50 also forms a closed profile. Structural members 46, 48, 50 typically belong to an inner or outer body-in-white-structure of the vehicle.

However, in both embodiments as illustrated in FIG. 2 and FIG. 3, all structural members 26, 34, 40, 42, 46, 48, 50 are covered by means of respective interior linings 36, 38, 56, 58, respectively. In the embodiment according to FIG. 3, the panel member 44 of the vehicle body component is covered by means of a transparent cover plate 28, which may comprise glass or a plastic material providing a sufficient and comparable degree of transparency. Also here, the cover 28 and the windscreen 12 are mounted to the vehicle body component 18 by way of mounts 31, 32. The mount 31 in the embodiment according to FIG. 3 is designed and configured as a sealing member. Mounting of the windscreen 12 and the cover panel 28 is further conducted by making use of adhesives 52 providing a non-disconnectible connection of the cover 28 and the windscreen to the vehicle body.

Both configurations according to FIG. 2 and according to FIG. 3 may further comprise a closed frame structure, wherein the structural members 26, 34 and/or the structural members 40, 42 are mutually interconnected by way of an upper and/or lower connecting piece 17, 19, as for instance illustrated in FIG. 1. This way, a closed frame structure can be established, inherently providing improved mechanical strength and rigidity.

FIG. 4 finally shows an enlarged view of an upper section of an A-pillar 16, 18 as shown in FIG. 2 or FIG. 3 in cross section. Here, the perforated panel member 24, 44 features regularly arranged through openings providing a sufficient transparency effect if seen from a particular distance. Preferably, size and distribution of the perforations in the panel member 24, 44 is chosen according to the distance between the respective pillar structure 16, 18 and the driver of the vehicle.

While at least one exemplary embodiment has been presented in the foregoing summary and detailed description, it should appreciated that a vast number of variations exists. It should also be appreciated that the exemplary embodiments are only examples, and are not intended to limit the scope, applicability, or configuration in any way. Rather, the foregoing summary and detailed description will provide those skilled in the art with a convenient roadmap for implementing at least one exemplary embodiment, it being understood, that various changes may be made in the function and arrangement of elements described in an exemplary embodiment without departing from the scope as set forth in the appended claims and their legal equivalence.

What is claimed is:

1. A vehicle body component, comprising:
a first structural member;
a second structural member; and
an at least partially transparent panel member configured to interconnect the first structural member and the second structural member.

2. The vehicle body component according to claim 1, wherein the at least partially transparent panel member comprises a perforated structure.

3. The vehicle body component according to claim 1, wherein the at least partially transparent panel member comprises perforated sheet metal.

4. The vehicle body component according to claim 1, wherein the vehicle body component comprises an A-pillar of a vehicle body.

5. The vehicle body component according to claim 1, wherein the vehicle body component comprises a B-pillar of a vehicle body.

6. The vehicle body component according to claim 1, wherein the vehicle body component comprises an C-pillar of a vehicle body.

7. The vehicle body component according to claim 1, wherein the first structural member and the second structural member forms a closed frame member, wherein an inner section of the closed frame member is traversed by the at least partially transparent panel member.

8. The vehicle body component according to claim 1, wherein the at least partially transparent panel member is integrally formed with at least one of the first structural member and the second structural member.

9. The vehicle body component according to claim 1, wherein the first structural member and the second structural member mutually merge.

10. The vehicle body component according to claim 1, wherein the at least partially transparent panel member comprises a plane shape.

11. The vehicle body component according to claim 1, wherein the at least partially transparent panel member comprises a bended shape.

12. The vehicle body component according to claim 1, wherein the at least partially transparent panel member and the first structural member forms an assembly unit adapted to be assembled to a vehicle body.

13. The vehicle body component according to claim 1, wherein the at least partially transparent panel member and the second structural member forms an assembly unit adapted to be assembled to a vehicle body.

14. The vehicle body component according to claim 1, wherein the first structural member comprises a closed profile.

15. The vehicle body component according to claim 1, wherein the second structural member comprises a closed profile.

16. The vehicle body component according to claim 1, wherein the first structural member comprises an open profile.

17. The vehicle body component according to claim 1, wherein the second structural member comprises a closed profile.

18. The vehicle body component according to claim 1,
wherein the first structural member and the second structural member comprise a u-shaped profile, and
wherein the at least partially transparent panel member is connected with a side shank portion of the first and the second structural member.
